(19) United States
(12) Patent Application Publication
(10) Pub. No.: US 2024/0340300 A1
(43) Pub. Date: Oct. 10, 2024

(54) SYSTEM FOR COMPONENT-LEVEL EXPOSURE ASSESSMENT IN A COMPUTING ENVIRONMENT

(71) Applicant: BANK OF AMERICA CORPORATION, Charlotte, NC (US)

(72) Inventor: Darren Roy Philips, Singapore (SG)

(73) Assignee: BANK OF AMERICA CORPORATION, Charlotte, NC (US)

(21) Appl. No.: 18/131,773

(22) Filed: Apr. 6, 2023

(51) Int. Cl. H04L 9/40; G06F 16/23

(52) U.S. Cl. CPC H04L 63/1433; G06F 16/2379

(57) ABSTRACT

Systems, computer program products, and methods are described herein for component-level exposure assessment in a computing environment. The present disclosure is configured to receive, from a distributed ledger, a likelihood of misfunction associated with a first component; receive a network interaction history of the first component with a second component; determine an updated likelihood of misfunction associated with the first component based on at least the network interaction history of the first component with the second component; and record the updated likelihood of misfunction associated with the first component in the distributed ledger.

### TECHNOLOGICAL FIELD

Example embodiments of the present disclosure relate to component-level exposure assessment in a computing environment.

### BACKGROUND

Computing environments today host a wide variety of network services, which often depend on each other to provide and support network-based services and applications. Entities managing the computing environments may wish to accurately, efficiently, and dynamically track whether a component (e.g., end-point device, servers, switches, repeaters, and/or the like) or an application installed therein, can be trusted.

Applicant has identified a number of deficiencies and problems associated with exposure assessment in a computing environment. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for component-level exposure assessment in a computing environment.

In one aspect, a system for component-level exposure assessment in a computing environment is presented. The system comprising: a processing device; a non-transitory storage device containing instructions when executed by the processing device, causes the processing device to: receive, from a distributed ledger, a likelihood of misfunction associated with a first component; receive a network interaction history of the first component with a second component; determine an updated likelihood of misfunction associated with the first component based on at least the network interaction history of the first component with the second component; and record the updated likelihood of misfunction associated with the first component in the distributed ledger.

In some embodiments, in executing instructions to record the updated likelihood of misfunction associated with the first component further causes the processing device to: generate a transaction object for the updated likelihood of misfunction associated with the first component; and deploy the transaction object on the distributed ledger.

In some embodiments, executing the instructions to deploy the transaction object on the distributed ledger further causes the processing device to: capture a distributed ledger address associated with the recording; generate a notification indicating that the transaction object has been created for the updated likelihood of misfunction associated with the first component, wherein the notification comprises at least the distributed ledger address; and transmit control signals configured to cause a user input device associated with a user to display the notification.

In some embodiments, executing the instructions further causes the processing device to: determine one or more security requirements associated with the second component; receive a likelihood of misfunction associated with the second component; determine one or more ingestion patterns related to the network interaction history of the first component with the second component; and determine the updated likelihood of misfunction associated with the first component based on at least the one or more security requirements associated with the second component, the likelihood of misfunction associated with the second component, and the one or more ingestion patterns.

In some embodiments, determining the one or more ingestion patterns further causes the processing device to: capture a data traffic related to the network interaction history of the first component with the second component over a period of time; and determine, using a machine learning (ML) subsystem, the one or more ingestion patterns for the first component based on at least the data traffic.

In some embodiments, executing the instructions further causes the processing device to: determine one or more instances of anomalous behavior associated with the first component based on at least the one or more ingestion patterns; and determine an updated likelihood of misfunction associated with the first component based on at least determining the one or more instances of anomalous behavior associated with the first component.

In some embodiments, executing instructions to determine the one or more ingestion patterns associated with the first component further causes the processing device to: deploy, via the ML subsystem, a trained ML model on the data traffic related to the network history of the first component with the second component captured over the period of time; and determine, using the trained ML model, the one or more ingestion patterns associated with the first component.

In some embodiments, executing instructions further causes the processing device to: generate a feature set using the data traffic related to the network history of the first component with the second component captured over the period of time; and train, using the ML subsystem, an ML model using the feature set to generate the trained ML model.

In some embodiments, executing the instructions further causes the processing device to: determine one or more security requirements associated with the first component; and determine the likelihood of misfunction associated with the first component based on at least the one or more security requirements associated therewith.

In another aspect, a computer program product for component-level exposure assessment in a computing environment is presented. The computer program product comprising a non-transitory computer-readable medium comprising code causing an apparatus to: receive, from a distributed ledger, a likelihood of misfunction associated with a first component; receive a network interaction history of the first component with a second component; determine an updated likelihood of misfunction associated with the first component based on at least the network interaction history of the first component with the second component; and record the updated likelihood of misfunction associated with the first component in the distributed ledger.

In yet another aspect, a method for component-level exposure assessment in a computing environment is presented. The method comprising: receiving, from a distributed ledger, a likelihood of misfunction associated with a first component; receiving a network interaction history of the first component with a second component; determining an updated likelihood of misfunction associated with the first component based on at least the network interaction history of the first component with the second component; and recording the updated likelihood of misfunction associated with the first component in the distributed ledger.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for component-level exposure assessment in a computing environment, in accordance with an embodiment of the disclosure;

FIGS. 2A-2B illustrate an exemplary distributed ledger technology (DLT) architecture, in accordance with an embodiment of the invention; and

FIG. 3 illustrates a process flow for component-level exposure assessment in a computing environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Computing environments today host a wide variety of network services, which often depend on each other to provide and support network-based services and applications. Entities managing the computing environments may wish to accurately, efficiently, and dynamically track whether a component (e.g., end-point device, servers, switches, repeaters, and/or the like) or an application installed therein, can be trusted. Therefore, there is a need for a system for component-level exposure assessment each time a component interacts with another component.

Accordingly, the present invention, (i) receives, from a distributed ledger, a likelihood of misfunction associated with a first component (or application associated therewith). A component may be deemed misfunctioning if the component is not operating as intended or programmed, the component is malfunctioning (e.g., device failure), subjected to maintenance, or is otherwise offline or inoperable. The likelihood of misfunction may provide an indication of trust associated with each component and represent a criticality of the component. The likelihood of misfunction may be determined based on at least security requirements associated with the component. Security requirements may be a statement of security functionality that ensures one of many different security properties of the component is being satisfied. The likelihood of misfunction for each component may be recorded in a distributed ledger associated therewith, (ii) receives a network interaction history of the first component with a second component. Network interaction history may refer to any data communication (data exchange) between the first component and the second component, (iii) determines an updated likelihood of misfunction associated with the first component based on at least the network interaction history of the first component with the second component. The updated likelihood of misfunction associated with the first component may be determined based on at least security requirements associated with the second component, a likelihood of misfunction associated with the second component, and ingestion patterns associated with the first component based on the network history of the first component with the second component. In particular, identifies specific ingestion patterns associated with the first component based on the network interaction history of the first component with the second component, and then determines whether any of these ingestion patterns reflect anomalous behavior, and (iv) records the updated likelihood of misfunction associated with the first component in the distributed ledger.

What is more, the present disclosure provides a technical solution to a technical problem. The technical solution presented herein allows for a more accurate determination of exposure for each component (or application associated therewith) that will effectively reduce the amount of computing resources, such as processing resources, storage resources, network resources, and/or the like, that are being used, providing a more accurate solution to problem, thus reducing the number of resources required to remedy any errors made due to a less accurate solution, remove manual input and waste from the implementation of the solution, thus improving speed and efficiency of the process and conserving computing resources, and determine an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

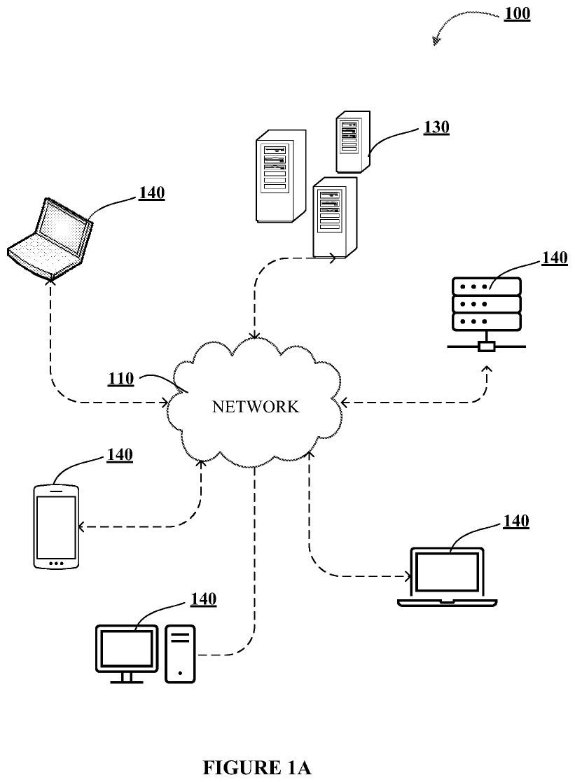

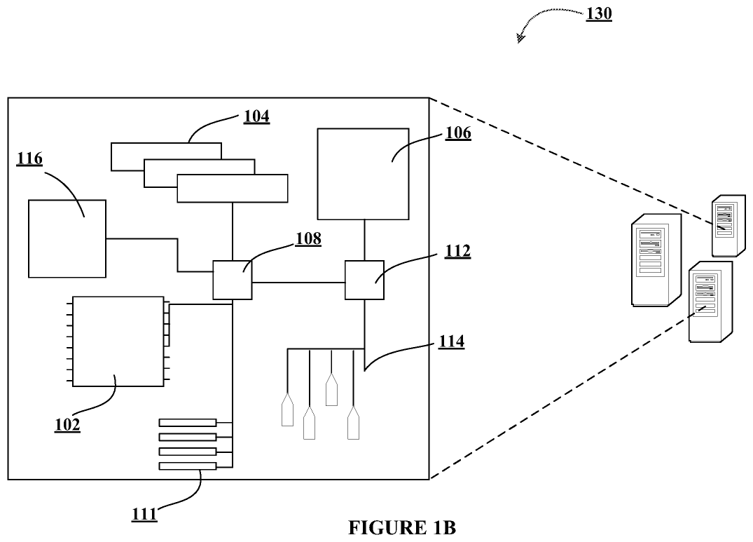

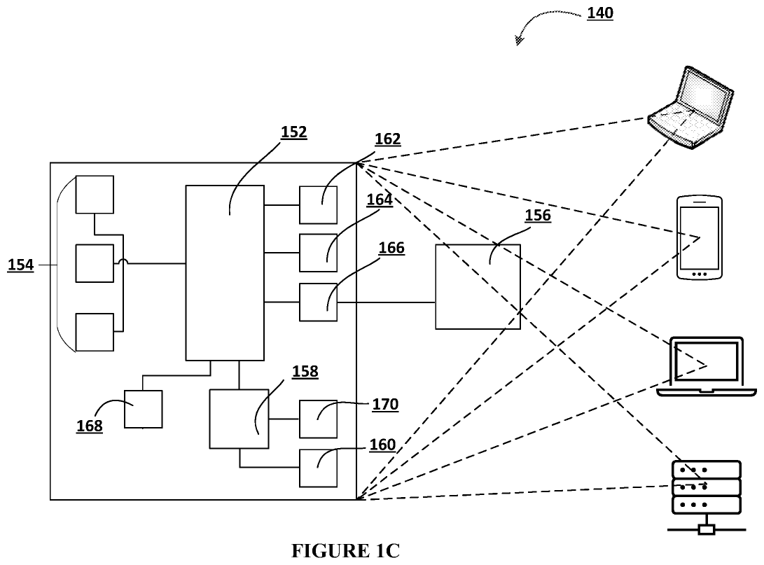

FIGS. 1A-1C illustrate technical components of an exemplary distributed computing environment for component-level exposure assessment in a computing environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

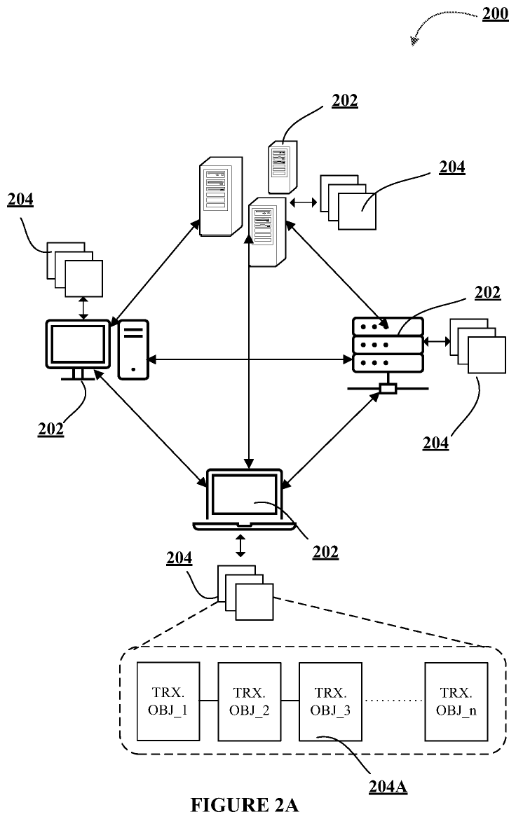

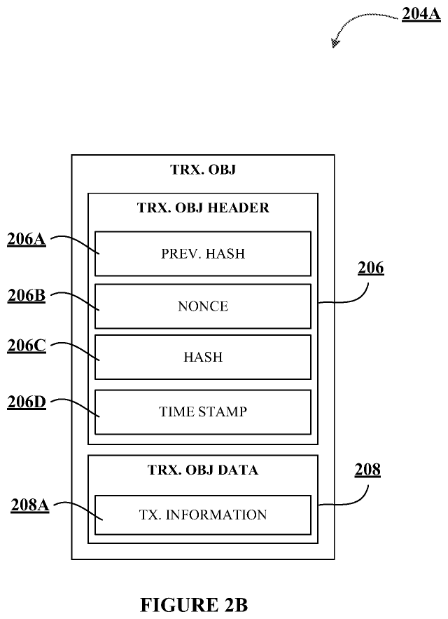

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B-a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

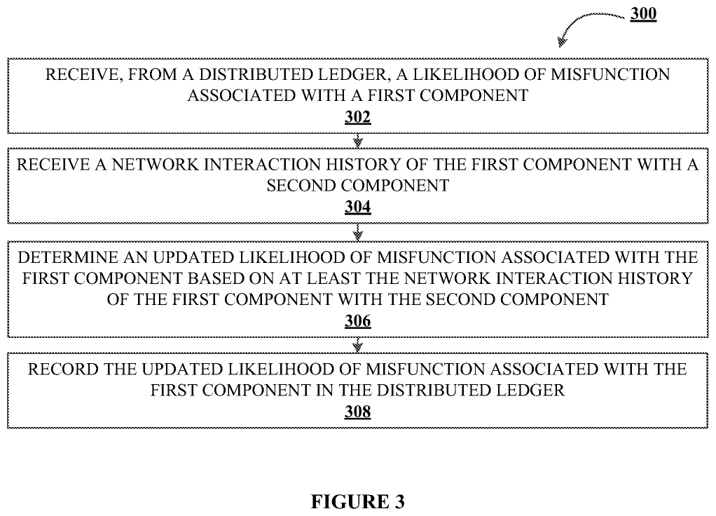

FIG. 3 illustrates a process flow for component-level exposure assessment in a computing environment, in accordance with an embodiment of the disclosure. As shown in block 302, the process flow includes receiving, from a distributed ledger, a likelihood of misfunction associated with a first component. As used herein, a component may be deemed misfunctioning if the component is not operating as intended or programmed, the component is malfunctioning (e.g., device failure), subjected to maintenance, or is otherwise offline or inoperable. As such, the likelihood of misfunction may provide an indication of trust associated with each component and represent a criticality of the component. For example, the lower the likelihood of misfunction, the more trustworthy the component is deemed to be, while the higher the likelihood of misfunction, the less trustworthy the component is deemed to be. In some embodiments, the likelihood of misfunction may be determined based on at least security requirements associated with the component. The security requirements may be a statement of security functionality that ensures one of many different security properties of the component (e.g., second component) is being satisfied. Security requirements may be derived based on industry standards, applicable regulations, a history of past vulnerabilities, history of network interactions of the component within a predetermined degree of freedom of connectivity of the component with one or more other components, and/or the like. Once determined, the likelihood of misfunction for each component may be recorded in a distributed ledger associated therewith.

Next, as shown in block 304, the process flow includes receiving a network interaction history of the first component with a second component. The network interaction history may refer to any data communication (data exchange) between the first component and the second component. Typically, network interaction history may be captured to detect any advanced persistent threat (APT), abnormal or excessive communication patterns and various malware activities. The network interaction history may either be captured directly from each component or from other components (e.g., routers, switches, firewalls, and/or the like) that establish communication between the components.

Next, as shown in block 306, the process flow includes determining an updated likelihood of misfunction associated with the first component based on at least the network interaction history of the first component with the second component. In some embodiments, the updated likelihood of misfunction associated with the first component may be determined based on at least security requirements associated with the second component, a likelihood of misfunction associated with the second component, and network interaction history of the first component with the second component.

In some embodiments, in determining the likelihood of misfunction, the system may determine instances of anomalous behavior associated with the first component based on the network history of the first component with the second component. These instances of anomalous behavior are then used to determine the updated likelihood of misfunction associated with the first component. In particular, the system may identify specific ingestion patterns associated with the first component based on the network interaction history of the first component with the second component, and then determine whether any of these ingestion patterns reflect anomalous behavior.

In some embodiments, the system may determine such ingestion patterns using a machine learning (ML) techniques. To this end, the system may deploy a trained ML model on the network interaction history of the first component with the second component over a period of time. A trained ML model may refer to a mathematical model generated by machine learning algorithms based on training data, to make predictions or decisions without being explicitly programmed to do so. To train the ML model, the system may generate a feature set using the data traffic related to the network history of the first component with the second component captured over the period of time. In response, the system may train, using the ML subsystem, an ML model using the feature set to generate the trained ML model.

The ML model represents what was learned by the selected machine learning algorithm and represents the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. ML algorithms may refer to programs that are configured to self-adjust and perform better as they are exposed to more data. To this extent, ML algorithms are capable of adjusting their own parameters, given feedback on previous performance in making prediction about a dataset.

The ML algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML model may be trained using repeated execution cycles of experimentation, testing, and tuning to modify the performance of the ML algorithm and refine the results in preparation for deployment of those results for consumption or decision making. The ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

When deployed, the system may determine, using the trained ML model, the one or more ingestion patterns associated with the first component. In some embodiments, in response to determining the ingestion patterns, the system may determine various instances of predictable and anomalous behavior for the first component. In one aspect, the behavior of the first component may be determined by comparing each instance of behavior with pre-defined behavioral characteristics to determine a similarity index. If the similarity index of a behavioral instance matches the similarity index of a pre-defined behavioral characteristic within a tolerance threshold, the instance is classified as belonging to the pre-defined behavioral class. Each anomalous behavior is further characterized based on a behavior type, a frequency of occurrence of the anomalous behavior, an impact of the anomalous behavior on other components (including the first component and the second component), and/or the like. These characterizations are then quantified using parametric estimation, and subsequently used, along with the security requirements associated with the second component, and the likelihood of misfunction associated with the second component, to determine the updated likelihood of malfunction of the first component.

Next, as shown in block 308, the process flow includes recording the updated likelihood of misfunction associated with the first component in the distributed ledger. In some embodiments, to record the updated likelihood of misfunction, the system may include generating a transaction object for the updated likelihood of misfunction associated with the first component. As described herein, the transaction object may include information associated with the component, such as the updated likelihood of misfunction, and the network interaction history of the first component with the second component, i.e., any network interaction history of the first component that has resulted in the likelihood of misfunction to require updating, a nonce-a randomly generated 32-bit whole number when the transaction object is created, and a hash value wedded to that nonce. In response to generating the transaction object, the system may include deploying the transaction object on the distributed ledger. When new transaction object is deployed on the distributed ledger, a distributed ledger address is generated for that new transaction object, i.e., an indication of where it is located on the distributed ledger. This distributed ledger address is captured for recording purposes. Then, the system may generate a notification indicating that the transaction object has been created for the updated likelihood of misfunction associated with the first component. Here, the notification may include the associated distributed ledger address. Once generated, the system may then transmit control signals configured to cause a user input device associated with a user to display the notification.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for component-level exposure assessment in a computing environment, the system comprising:
a processing device;
a non-transitory storage device containing instructions when executed by the processing device, causes the processing device to:
receive, from a distributed ledger, a likelihood of misfunction associated with a first component;
receive a network interaction history of the first component with a second component;
determine an updated likelihood of misfunction associated with the first component based on at least the network interaction history of the first component with the second component; and
record the updated likelihood of misfunction associated with the first component in the distributed ledger.

2. The system of claim 1, wherein executing instructions to record the updated likelihood of misfunction associated with the first component further causes the processing device to:
generate a transaction object for the updated likelihood of misfunction associated with the first component; and
deploy the transaction object on the distributed ledger.

3. The system of claim 2, wherein executing the instructions to deploy the transaction object on the distributed ledger further causes the processing device to:
capture a distributed ledger address associated with the recording;
generate a notification indicating that the transaction object has been created for the updated likelihood of misfunction associated with the first component, wherein the notification comprises at least the distributed ledger address; and
transmit control signals configured to cause a user input device associated with a user to display the notification.

4. The system of claim 1, wherein executing the instructions further causes the processing device to:
determine one or more security requirements associated with the second component;
receive a likelihood of misfunction associated with the second component;
determine one or more ingestion patterns related to the network interaction history of the first component with the second component; and
determine the updated likelihood of misfunction associated with the first component based on at least the one or more security requirements associated with the second component, the likelihood of misfunction associated with the second component, and the one or more ingestion patterns.

5. The system of claim 4, wherein determining the one or more ingestion patterns further causes the processing device to:
capture a data traffic related to the network interaction history of the first component with the second component over a period of time; and
determine, using a machine learning (ML) subsystem, the one or more ingestion patterns for the first component based on at least the data traffic.

6. The system of claim 5, wherein executing instructions to determine the one or more ingestion patterns associated with the first component further causes the processing device to:
deploy, via the ML subsystem, a trained ML model on the data traffic related to the network history of the first component with the second component captured over the period of time; and
determine, using the trained ML model, the one or more ingestion patterns associated with the first component.

7. The system of claim 6, wherein executing instructions further causes the processing device to:
generate a feature set using the data traffic related to the network history of the first component with the second component captured over the period of time; and
train, using the ML subsystem, an ML model using the feature set to generate the trained ML model.

8. The system of claim 1, wherein executing the instructions further causes the processing device to:
determine one or more security requirements associated with the first component; and
determine the likelihood of misfunction associated with the first component based on at least the one or more security requirements associated therewith.

9. A computer program product for component-level exposure assessment in a computing environment, the computer program product comprising a non-transitory computer-readable medium comprising code causing an apparatus to:
receive, from a distributed ledger, a likelihood of misfunction associated with a first component;
receive a network interaction history of the first component with a second component;
determine an updated likelihood of misfunction associated with the first component based on at least the network interaction history of the first component with the second component; and
record the updated likelihood of misfunction associated with the first component in the distributed ledger.

10. The computer program product of claim 9, wherein, in storing the updated likelihood of misfunction associated with the first component, the code further causes the apparatus to:
generate a transaction object for the updated likelihood of misfunction associated with the first component; and
deploy the transaction object on the distributed ledger.

11. The computer program product of claim 10, wherein, in deploying the transaction object on the distributed ledger, the code further causes the apparatus to:
capture a distributed ledger address associated with the recording;
generate a notification indicating that the transaction object has been created for the updated likelihood of misfunction associated with the first component, wherein the notification comprises at least the distributed ledger address; and
transmit control signals configured to cause a user input device associated with a user to display the notification.

12. The computer program product of claim 10, wherein the code further causes the apparatus to:
determine one or more security requirements associated with the second component; receive a likelihood of misfunction associated with the second component;
determine one or more ingestion patterns related to the network interaction history of the first component with the second component; and
determine the updated likelihood of misfunction associated with the first component based on at least the one or more security requirements associated with the second component, the likelihood of misfunction associated with the second component, and the one or more ingestion patterns.

13. The computer program product of claim 12, wherein, in determining the one or more ingestion patterns, the code further causes the apparatus to:
capture a data traffic related to the network interaction history of the first component with the second component over a period of time; and
determine, using a machine learning (ML) subsystem, the one or more ingestion patterns for the first component based on at least the data traffic.

14. The computer program product of claim 13, wherein, in determining the one or more ingestion patterns associated with the first component, the code further causes the apparatus to:
deploy, via the ML subsystem, a trained ML model on the data traffic related to the network history of the first component with the second component captured over the period of time; and
determine, using the trained ML model, the one or more ingestion patterns associated with the first component.

15. The computer program product of claim 14, wherein the code further causes the apparatus to:
generate a feature set using the data traffic related to the network history of the first component with the second component captured over the period of time; and
train, using the ML subsystem, an ML model using the feature set to generate the trained ML model.

16. The computer program product of claim 9, wherein the code further causes the apparatus to:
determine one or more security requirements associated with the first component; and
determine the likelihood of misfunction associated with the first component based on at least the one or more security requirements associated therewith.

17. A method for component-level exposure assessment in a computing environment, the method comprising:
receiving, from a distributed ledger, a likelihood of misfunction associated with a first component;
receiving a network interaction history of the first component with a second component;
determining an updated likelihood of misfunction associated with the first component based on at least the network interaction history of the first component with the second component; and
recording the updated likelihood of misfunction associated with the first component in the distributed ledger.

18. The method of claim 17, wherein, in storing the updated likelihood of misfunction associated with the first component, the method further comprises:
generating a transaction object for the updated likelihood of misfunction associated with the first component; and
deploying the transaction object on the distributed ledger.

19. The method of claim 18, wherein to deploy the transaction object on the distributed ledger, the method further comprises:
capturing a distributed ledger address associated with the recording;
generating a notification indicating that the transaction object has been created for the updated likelihood of misfunction associated with the first component, wherein the notification comprises at least the distributed ledger address; and
transmitting control signals configured to cause a user input device associated with a user to display the notification.

20. The method of claim 19, wherein the method further comprises:
determining one or more security requirements associated with the second component;
receiving a likelihood of misfunction associated with the second component;
determining one or more ingestion patterns related to the network interaction history of the first component with the second component; and
determining the updated likelihood of misfunction associated with the first component based on at least the one or more security requirements associated with the second component, the likelihood of misfunction associated with the second component, and the one or more ingestion patterns.
